(19) United States
(12) Patent Application Publication
(10) Pub. No.: US 2011/0219921 A1
(43) Pub. Date: Sep. 15, 2011

(54) Cutting System

(76) Inventor: Andrew Peter Pohl, Hampton, VA (US)

(21) Appl. No.: 12/723,394

(22) Filed: Mar. 12, 2010

(51) Int. Cl. B26D 5/38

(52) U.S. Cl. 83/13; 83/431

(57) ABSTRACT

A cutting system for cutting natural or composite products is disclosed. The cutting system includes a fixed shear cutting blade having a cutting edge that faces upwardly. The cutting system also includes a movable ram positioned above the cutting edge. The movable ram can be moved upwardly and downwardly relative to the cutting edge. In use of the cutting system, a product desired to be cut is fed between the movable ram and the cutting edge of the cutting blade. By moving the movable ram downwardly toward the cutting blade, the product is compressed against the cutting blade thereby causing the cutting edge of the cutting blade to cut upwardly through the product.

### TECHNICAL FIELD

The present disclosure relates generally to cutting systems. More particularly, the present disclosure relates to systems using shear cutting blades for cutting composite materials.

### BACKGROUND

Formed composite products are often cut to size or trimmed using a hydraulic shearing device. A typical hydraulic shearing device includes a shear cutting blade that is moved by a hydraulic drive. The composite product desired to be cut is typically supported on a cutting table with a portion overhanging an edge of the table. The movable shear cutting blade is hydraulically driven downwardly past the edge of the table to form a cut between the portion of the composite product on the table and the portion of the composite product overhanging the edge of the table. One problem associated with such hydraulic shearing devices is that the portion of the composite product that is not supported on the cutting table can be damaged during the cutting process. Additionally, the movement of the cutting blade is difficult to precisely control as it is influenced by many factors such as the shear cutting blade construction and rigidity, and the density or composition of the composite product being sheared. Inaccuracy in shearing can result in wasted material relating to rejected product.

Other types of systems for cutting composite products include laser cutters and water jet cutters. However, laser cutters cut using a burning action which can release unwanted emissions into the air. Also, water-jet cutters are typically expensive and have fairly high energy requirements.

As a result of the above problems, manufacturers of composite products often rely on hand trimming or cutting. What is needed is an improved cutting system for cutting composite products and other items.

### SUMMARY

One aspect of the present disclosure relates to a device for efficiently cutting or trimming products. Example products include composite materials such as composite materials formed through a pressure molding process in which a mixture of materials (e.g., flowable materials, binders and fillers) are pressed together within a mold using a platen press. Example composite products include hard-rubber composite products, wood composite products or other composite products. However, aspects of the present disclosure are also applicable to other materials such as wood, paper-board, multi-density fibre board (MDF), etc.

Another aspect of the present disclosure relates to a system and method for preparing a composite product such that the composite product can be quickly and accurately trimmed or cut to size. In one embodiment, the composite product can be formed using a compression molding process in which the product is formed within a mold compressed together through the use of a platen press. In certain embodiments, the molding process can include forming predetermined cut alignment/registration locations within the product to control the accuracy of a subsequent cutting process.

Still another aspect of the present disclosure relates to a shear cutting system including a fixed shear cutting blade and a movable press surface that forces a product desired to be cut against the shear cutting blade. In a preferred embodiment, the product being sheared has first and second portions located on opposite sides of a cutting edge of the fixed shear cutting blade, and the movable press surface supports both the first and second portions of the product during the cutting process.

A variety of additional aspects will be set forth in the description that follows. The aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a schematic, cross-sectional view of a shear cutting system in accordance with the principles of the present disclosure, the system is shown in a product feed orientation;

FIG. 2 shows the shear cutting system of FIG. 1 with a pre-defined cut location of a product desired to be cut aligned with a shear cutting blade of the shear cutting system;

FIG. 3 shows the shear cutting system of FIGS. 1 and 2 with a moveable ram of the shear cutting system lowered to a cutting position;

FIG. 4 is a top plan view of an example composite product adapted to be cut by the shear cutting system of FIGS. 1-3, the composite product has cut alignment structures incorporated therein; and

FIG. 5 is right end view of the composite product of FIG. 4.

### DETAILED DESCRIPTION

Certain aspects of the present disclosure relate to a system and method for cutting a product wherein a movable structure is used to force the product desired to be cut against the shear cutting blade while the shear cutting blade remains substantially fixed during the cutting process. In certain embodiments, the movable structure can be referred to as a ram, press, push-plate, pressure plate, compression plate, or like terms. In certain embodiments, the movable structure supports the product being cut on opposite sides of the shear cutting blade during the cutting process. Other aspects of the present disclosure relate to a product having integrated structures for facilitating precise cutting of the product. In one embodiment, products in accordance with the principles of the present disclosure include integrated alignment structures that promote self alignment of a shear cutting blade relative to the products. In certain embodiments, the integrated alignment structures can include tapered features (e.g., v-grooves) for guiding the shear cutting blade to a predefined and accurately positioned cutting location.

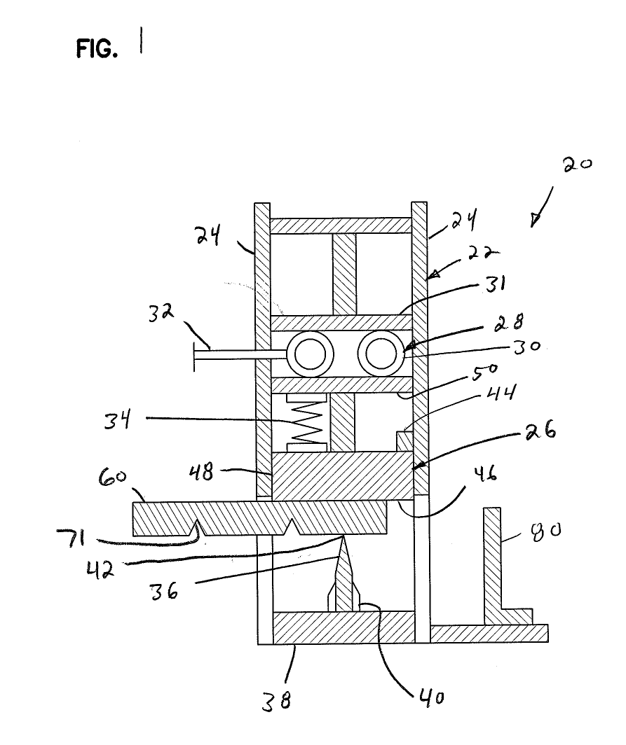

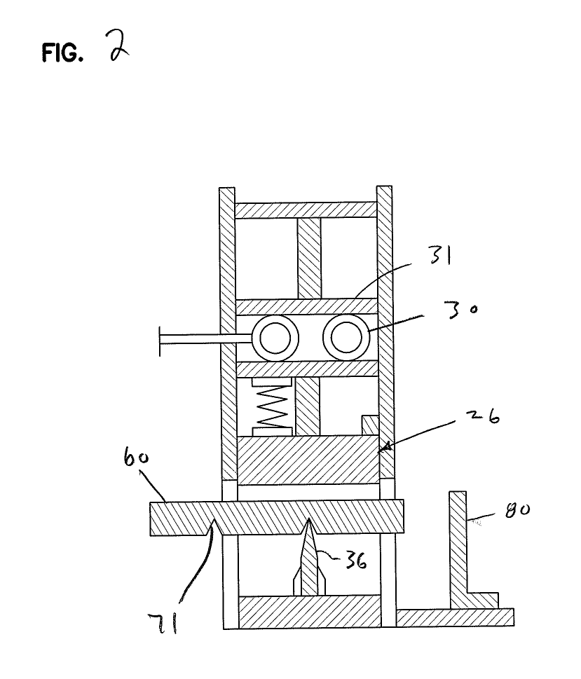

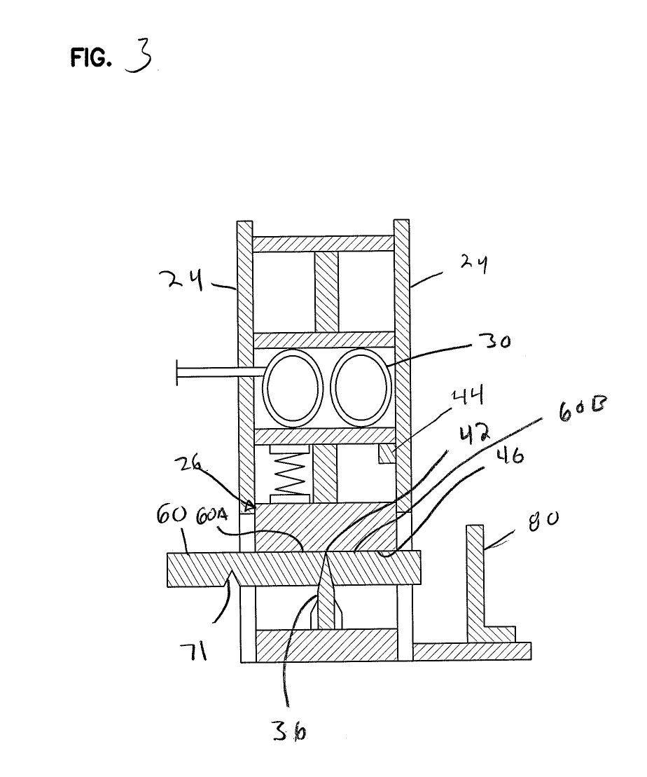

FIGS. 1-3 show a shear cutting system 20 in accordance with the principles of the present disclosure. The shear cutting system 20 includes a frame 22 including side rails 24 between which a movable ram 26 is reciprocally mounted for up and down movement. In other words, the movable ram 26 is configured to slide up and down with the up and down movement of the movable ram 26 guided by the side rails 24. The shear cutting system 20 also includes a drive mechanism 28 for moving the movable ram 26 downwardly to a lower cutting position (see FIG. 3) and for returning the movable ram 26 from the lower cutting position to a raised product feed position (see FIGS. 1 and 2). In the depicted embodiment, the drive mechanism 28 includes inflatable bellows 30 that are inflated by an air line 32 to drive the movable ram 26 downwardly from the raised position to the lowered position. The inflatable bellows 30 are positioned between the movable ram 26 and a fixed plate 31 that is fixed against upward and downward movement relative to the side rails 24. The drive mechanism 28 also includes a spring 34 for returning the movable ram 26 from the lowered position to the raised position when the inflatable bellows 30 are deflated. While the drive mechanism 28 has been depicted as a pneumatic drive, it will be appreciated that other drive mechanisms such as hydraulic drives, pneumatic or hydraulic cylinders, mechanical drives or other structures could also be used.

Referring still to FIG. 1, the shear cutting system 20 further includes a shear cutting blade 36 mounted to a base plate 38 by a blade holder 40. The blade holder 40 secures the shear cutting blade 36 at a fixed location relative to the base plate 38. When mounted to the base plate 38 by the blade holder 40, the shear cutting blade 36 has a cutting edge 42 that faces in an upward direction. The blade holder 40 and the shear cutting blade 36 are mounted to the base plate 38 at a position directly below the movable ram 26.

The shear cutting system 20 further includes a stop 44 for precisely setting the exact location of the cutting position of the movable ram 26. Specifically, when a bottom cutting surface 46 of a lower plate 48 of the movable ram 26 reaches the cutting edge 42 of the shear cutting blade 36 (as shown at FIG. 3), an upper plate 50 of the movable ram 26 engages the stop 44 to provide a positive stop that prevents the cutting surface 46 from being driven against the cutting edge 42. In this way, positive stop 44 allows the cutting surface 46 to stop precisely at the cutting edge 42 during a cutting operation thereby preventing damage of the cutting edge 42 and the cutting surface 46.

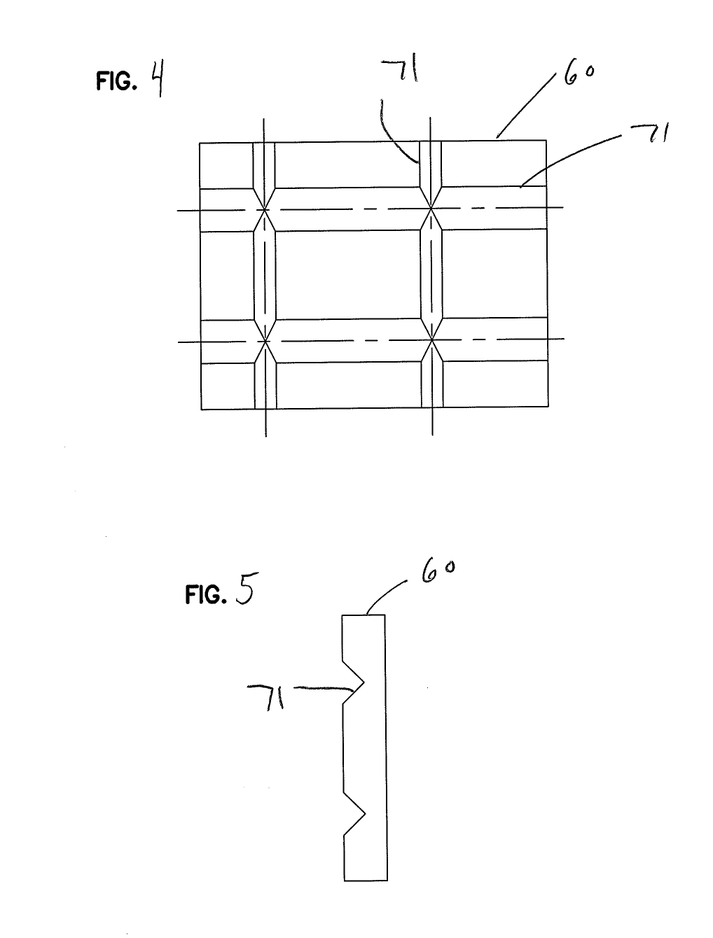

Referring again to FIG. 1, the shear cutting system 20 is adapted to cut or trim a product 60. In certain embodiments, product 60 can be a composite product including a mixture of materials or a non-composite product made of one type of material. Preferred composite products can be manufactured using a compression molding process in which a mixture of materials (e.g. a flowable material such as a polymeric material or chopped rubber, a binder such as a thermo-plastic or duro-plastic material including epoxies, urethanes, and polyesters, etc., and a filler such as sand, sawdust, ground paper, etc.). The mixture of materials can be placed in a compression mold having separate mold components that are compressed together to compress and melt the flowable material and to form the material within the mold to a desired shape thereby forming a pressed composite product. In certain embodiments, the mold can be shaped to provide the product with cut alignment structures. For example, as shown at FIGS. 4 and 5, a product 60 is provided with cut alignment structures in the form of v-grooves 71 that are pre-formed within the product during a molding process. As shown at FIG. 4, the v-grooves 71 are arranged in a crisscross pattern thereby allowing a given molded product to be sectioned into multiple pieces using the shear cutting system 20. The v-grooves 71 include tapered structures that facilitate self-alignment of the cutting edge 42 of the shear cutting blade 36 during the cutting process.

In use of the shear cutting system 20, the movable ram 26 is initially positioned in the raised, product feed position. As so positioned, the cutting surface 46 of the movable ram 26 is spaced directly above the cutting edge 42 of the shear cutting blade 36 as shown at FIG. 1. The product 60 is then fed (e.g., manually or automatically) laterally through the space between the cutting surface 46 and the shear cutting blade 36. Preferably, the product 60 is oriented with the v-grooves 71 facing downwardly and generally parallel to the cutting edge 42 of the shear cutting blade 36. The product 60 is slid laterally across the cutting edge 42 until the cutting edge 42 is received within the desired cut location defined by the given v-grooves 71 (see FIG. 2). For example, when the v-groove 71 reaches the cutting edge 42, the product 60 automatically drops downwardly such that the cutting edge 42 is received within the v-groove 71. In this manner, the v-groove 71 provides automatic, self-alignment of the cutting edge 42 at the desired cut location of the product 60. If desired, a rough stop 80 can be used in combination with or in place of the integrated cut alignment structures to position the product with cutting edge 42 located at the desired cut location. It will be appreciated that the stop 80 can be movable (e.g., the stop 80 can reciprocate up and down or slide in and out) so as to not interfere with movement of the product 60 between cutting operations. Additionally, the stop 80 can be set at different locations relative to the shear cutting blade 36 to set different cut locations.

Once the cutting edge 42 has been received within the v-groove 71 thereby self-aligning the cutting edge 42 at the desired cut location, the inflatable bellows 30 are inflated thereby driving the movable ram 26 downwardly from the raised, product feed position to the lowered, cutting position (see FIG. 3). As the movable ram 26 is driven downwardly, the product 60 is compressed against the cutting edge 42 thereby causing the cutting edge 42 to shear through the product at the cut location. During the cutting process, the cutting surface 46 supports the top of the product 60 on both sides of the cutting edge 42 thereby ensuring a clean shear-cut of the product. For example, as shown at FIG. 2, the cutting surface 46 supports first and second portions 60A, 60B of the product 60 with the first and second portions 60A, 60B being located on opposite sides of the cutting edge 42. Additionally, during the cutting process, the shear cutting blade 36 is retained in a fixed, rigid position relative to the bottom base plate 38 thereby ensuring an exact cutting angle that doesn't change during the cutting process. The bottom of the product 60 is unsupported on opposite sides of the cutting blade 36 during the cutting process.

From the foregoing detailed description, it will be evident that modifications and variations can be made in the systems of the present disclosure without departing from the spirit or scope of the invention. For example, in other embodiments, the relative orientations of the shear cutting blade and the ram may be modified. In one alternative embodiment, the shear cutting blade can be positioned above the ram such that the ram moves upwardly to cut product. In another alternative embodiment, the shear cutting blade can be positioned laterally adjacent to the ram such that the ram is moved laterally to cut product.

What is claimed is:

1. A cutting apparatus for cutting composite or natural products, the cutting apparatus comprising:
a bottom plate;
a cutting blade mounted at a fixed position relative to the bottom plate, the cutting blade being mounted with a cutting edge facing in an upward direction;
a movable press element mounted directly above the cutting edge of the cutting blade;
a drive mechanism for driving the movable press element downwardly toward the cutting edge of the cutting element, wherein a product desired to be cut is positioned between the movable press element and the cutting edge and the product is cut by moving the movable press element downwardly with the drive mechanism causing the product to be pressed downwardly against the cutting edge thereby causing the cutting edge to cut through product, and wherein the movable press element includes a press surface that supports the product on opposite sides of the cutting edge during the cutting process.

2. A product formed with a plurality of blade alignment structures integrated therein to facilitate positioning a cutting-blade at a desired cut location.

3. A method for cutting a product comprising:
forming a product including a cutting blade alignment structure integrated therein;
aligning a fixed cutting blade at a desired cut location of the product by receiving the cutting blade within the cutting blade alignment structure; and
compressing the product against the cutting blade with a movable component to cut the product at the desired cut location.

4. The method of claim 3, further comprising supporting the product with the movable component on opposite sides of the cutting blade during the cutting process.

5. The method of claim 4, wherein the cutting blade alignment structure comprises a v-groove formed in an underside of the product, wherein the cutting blade is mounted at a fixed location with a cutting edge facing upwardly, wherein the cutting blade self-aligns at the desired cut location by dropping the v-groove over the cutting blade via gravity, and wherein the movable component is moved downwardly during the cutting process.
